(19) United States
(12) Patent Application Publication
(10) Pub. No.: US 2025/0021927 A1
(43) Pub. Date: Jan. 16, 2025

(54) A METHOD AND A SYSTEM FOR CONTROLLING MULTIPLE WIRELESS LOGGER DEVICES ASSOCIATED WITH THE SAME SHIPMENT

(71) Applicant: CONTROLANT HF., Kopavogur (IS)

(72) Inventor: Gisli HERJOLFSSON, Kopavogur (IS)

(21) Appl. No.: 18/712,824

(22) PCT Filed: Dec. 9, 2022
(86) PCT No.: PCT/EP2022/085215

§ 371 Date: May 23, 2024

(30) Foreign Application Priority Data
Dec. 9, 2021 (EP) 21213444.9

(51) Int. Cl. G06Q 10/0833; H04Q 9/00

(52) U.S. Cl. CPC G06Q 10/0833; H04Q 9/00; H04Q 2209/883

(57) ABSTRACT

A method of controlling multiple wireless logger devices is associated with a common shipment, where the logger devices are configured to measure environmental parameters while transporting the shipment from an origin location to a destination location and temporarily wake-up to transmit the measured environmental parameters together with position data of the logger devices to an external data processing device. Each of the logger devices includes: at least one sensing device for measuring at least one environmental parameter of the shipment, and a communication module for transmitting the measured environmental parameter to the external data processing device. The method includes configuring the logger devices to sequentially spread-out the transmission of the measured environmental parameters in a controlled way together with the position data for the common shipment, where the sequentially spread-out transmission is repetitively performed within a fixed time-interval.

### FIELD OF THE INVENTION

The present invention relates to a method and a system for controlling multiple of wireless logger devices associated with the same shipment.

### BACKGROUND OF THE INVENTION

With the expansion and growth of global sourcing in the supply chain, more prevalent interest has been placed on automatic electronic time and monitoring of environment-related parameters to increase food and drug safety and improve food defense systems throughout all areas of production, processing, storage, transportation, and operations. Food and drugs require proper handling of environment-related parameters such as temperature during transport to assure shelf life, longevity, and safety.

Logger devices are electronic monitoring devices commonly used for these purposes, namely, to automatically monitor and record various environmental-related parameters of a shipment throughout a supply chain, these parameters include temperature, humidity, acceleration, and air pressure, over time. A recent example of the importance of such logger devices is the temperature monitoring of the COVID-19 vaccines, which is a key critical monitoring parameter.

Some of the logger devices used today act as real-time monitoring devices, meaning that measured environmental-related parameters such as the temperature for a shipment are sent to an external data processing device (which may also be understood as a cloud-based system platform) with a fixed wake-up interval along with the position data of the logger devices. The fact that this data may be available in real-time improves the visibility of the shipment and allows customers and suppliers with such a solution to act in time in case of failures, e.g. temperature drop.

FIG. 1 shows an example of a shipment with a 3-hour fixed wake-up interval. In some cases, it may be beneficial to use several logger devices for such a shipment, as example, the same shipment may consist of three pallets of goods such as medicine, or food products. In this scenario, three logger devices 101-103 are associated with this single shipment 111 e.g. one for each pallet, where the pallets may be placed in a container or a vehicle.

When starting such a shipment each logger device may be started manually, and as illustrated here the wake-up interval for the three logger devices is 3 hours where the logger devices are instructed to wake up and to transmit measured environmental-related parameters 104-106 along with the position of the logger devices. The measured environmental-related parameters, and in particular the temperature parameter is measured with a fixed frequency, such as once every 10 minutes, meaning that 6 temperature measurements are provided every hour. In this scenario, when the logger devices wake up, they send all the measured data and the current position of the shipment (logger devices). Thus, in this example, all the temperature measurements are sent (3*6=18 temperature measurements) along with the current position, which may e.g. be determined based on the use of a nearby cell tower triangulation.

However, the individual wake-up frequency of each individual logger is either random or depends on when the logger devices were started. As illustrated here, if the time from where the first logger and the last logger were started is 15 minutes, they may wake-up as shown where the wake up frequency is distributed over the 15 minutes time windows meaning that the position of the shipment is given in these 15 minutes time windows.

### SUMMARY OF THE INVENTION

It is an object of the embodiments of the invention to provide a method and a system for operating multiple logger devices associated with one and the same shipment in a controlled way with the aim of optimizing the power use of the logger devices or enhancing the resolution of the position data of the shipment.

In general, the invention preferably seeks to mitigate, alleviate or eliminate one or more of the above-mentioned disadvantages of the prior art singly or in any combination. In particular, it may be seen as an object of the embodiments of the present invention to provide a method and a system for improving data visibility of a shipment which solves the above-mentioned problems, or/and other problems.

To better address one or more of these concerns, in a first aspect of the invention a method is provided for controlling multiple wireless logger devices associated with a common shipment, where the logger devices are configured to measure environmental parameters while transporting the shipment from an origin location to a destination location and temporarily wake-up to transmit the measured environmental parameters together with position data of the logger devices to an external data processing device, where each of the logger devices comprises:
at least one sensing device for measuring at least one environmental parameter of the shipment, and
a communication module for transmitting the measured environmental parameter to the external data processing device,
   wherein the method comprises configuring the logger devices to sequentially spread out the transmission of the measured environmental parameters in a controlled way together with the position data for said common shipment, where the sequential spread-out transmission is repetitively performed within a fixed wake-up interval.

Accordingly, a method is provided that enables distributing the wake-up frequency of the individual logger devices in a controlled way and adapting it e.g. to the customer's needs. This may as an example be beneficial when the resolution of the position data for the shipment is relevant, hence the logger devices may be configured such that they wake up in a ‘staggered wake up’ and spread up the wake-up periods such that a better or optimal data distribution of the position of the shipment is obtained. Thus, instead of e.g. having the wake-up periods for three logger devices in the first 15 minutes, and again in 2-3 hours later, this may be controlled such that they wake up in a way that provides better distribution of the data. This may be highly relevant if a disruption in the shipment occurs, e.g. temperature goes below a pre-defined target value, where such a disruption may be identified sooner instead of e.g. 2-hour delay.

In some scenarios, it may be more relevant to have a primary focus on the power usage of the power sources powering the logger devices at the cost of the resolution of the position data meaning that e.g. referring to the previous example, it may be more beneficial to work with the 3-hour wake-up interval, and instead let one logger at a time wake-up every three hours. Each wake-up where the communication module is moved from a low-power mode (or off-mode) to a higher energy mode where the logger device communicates with e.g. cellular network which is very energy demanding. This means that one logger needs to wake-up every nine hours, instead of every three hours, which obviously will result in saving the power of the logger devices.

The term shipment may according to the present invention be understood as food products, or medicine which may e.g. be packed in one or more container(s), placed on one or more pallet(s), in one or more box(es) and is transported by any type of transport vehicle, e.g. ship, aircraft, car etc.

In one embodiment, the step of configuring the logger devices includes scheduling a fixed transmission sequence between individual logger devices. Referring to the above-mentioned example, this means that preferably each logger device has associated an Identification number/code (ID number/code) where the fixed sequence stands for a fixed ID number/code sequence. An example of such a sequence for said 3 logger devices would e.g. be the sequences: ID1-ID2-ID3, where this sequence is then repeated. Accordingly, a simple solution is proved for generating such a spread-out transmission schedule for the data loggers.

In one embodiment, the transmission sequence of the logger devices is scheduled such that a single logger transmits the measured environmental parameter(s) together with position data of the logger device once at a time. In that way, maximum distribution is obtained and thus e.g. the resolution of the position data of the logger devices is maximized.

In one embodiment, the time interval between the logger devices is distributed evenly. This means that each logger device transmits the measured environmental parameters together with the position data of the logger devices once every wake-up interval, but due to the transmission planning this is distributed evenly over the wake-up interval. Referring to the above-mentioned example, this means that each logger device transmits the measured environmental parameters together with the position data of the logger devices every three hours, but the transmission schedule results in that once every hour the measured environmental parameters together with position data of the logger devices will be transmitted to the external data processing device. As an example, logger device ID1 transmits at 12:00, logger device ID2 transmits at 13:00 and logger device ID3 transmits at 14:00, ID1 transmits at 15:00 (i.e. three hours later) etc.

In one embodiment, each of the logger devices further comprises a built-in clock module, where the step of configuring the logger devices is triggered through remotely transmitted configuration messages sent to each individual logger device and received by the communication module of each individual logger device, where the configuration messages contain a time-schedule indicating when each individual logger device must wake-up to transmit measured environmental parameter(s) together with the position data of the logger device to the external data processing device. Referring to the previous example, logger device ID1 receives a configuration message which amongst other information relating to the shipment assigns the logger device a timeslot when it is to transmit (go temporarily to wake-up mode at 12:00) and every three hours after that, logger device ID2 receives a configuration message which amongst other information relating to the shipment assigns the logger device another timeslot e.g. 13:00 when it is to transmit (go temporarily to wake-up mode) and every three hours after that, and logger device ID3 receives a configuration message which amongst other information relating to the shipment assigns the logger device with yet another timeslot e.g. 14:00 when it is to transmit (go temporarily to wake-up mode) and every three hours after that. Other information relating to the shipment is contained in the configuration messages might be e.g. any type of restriction parameters, e.g. temperature restrictions, such as that the temperature of the shipment is not allowed to go below and/or above a certain temperature threshold value. In such an exceptional cases, one or more of the logger devices upon detection would automatically go to wake-up mode to send this to the external data processing device.

In one embodiment, the communication module comprises a modem such as a cellular modem controlled by a processor comprised in each of the logger devices, where the step of temporarily waking-up the logger devices to transmit the measured environmental parameters together with position data of the logger devices to the external data processing device includes temporarily activating, by the processor, the modem from being in a sleep-mode to a wake-up mode while the transmission takes place and e.g. the cellular modem is communicating with e.g. a cellular network such as 2G, 3G, 4G or 5G. The term sleep-mode may according to the present invention also be referred to as a low-power mode or off-mode, and the wake-up mode may be understood as a higher-power mode where the logger device has sufficient energy to transmit data to the external data processing device.

The position of the logger devices and thus the shipment may as an example be provided by use of a cell tower triangulation. Other embodiments which are well known to a person skilled person in the art such as identifying the location of the logger devices via Wi-Fi networks.

In one embodiment, the measured environmental parameters are selected from one or more of the following: temperature, humidity, acceleration, vibration, light intensity and/or air pressure.

In one embodiment, the at least one sensing device includes a temperature sensor, where temperature measurement takes place at a pre-defined time interval, wherein the step of configuring the logger devices to sequentially spread-out the transmission of the measured environmental parameters together with the position data for said common shipment is performed either prior to or subsequent to the temperature measurements. It is thus ensured that the wake-up mode of the data logger, i.e. where the modem is in cellular connection to a cellular network, does not influence the temperature measurement, but the modem in such a wake-up mode (higher energy-state) causes an increase of heat fluctuations in the logger device and thus can affect the accuracy of the temperature measurement.

In a second aspect of the invention, a system is provided for monitoring environmental parameters of a shipment while transporting the shipment from an origin location to a destination location, comprising:
an external data processing device,
two or more wireless logger devices associated with said shipment configured to measure the environmental parameters of the shipment while transporting the shipment from an origin location to a destination location, where each logger device comprises:
   a processor,
   at least one sensing device for measuring at least one environmental parameter of the shipment,
   a communication module operated by the processor where the operation includes temporarily setting the logger device in a wake-up mode while transmitting measured environmental parameter(s) together with position data of the logger device to the external data processing device, and
a scheduling module configured to generate a transmission schedule for the two or more logger devices such that the transmission of the measured environmental parameters together with the position data for said common shipment is sequentially spread out, where the sequentially spread-out transmission is repetitively performed within a fixed time-interval.

In an embodiment, the schedule module is comprised within the external data processing device, where each of the logger devices further comprises a built-in clock module, where the step of configuring the logger devices is triggered through a configuration message sent from the external data processing device to each individual logger device and received by the communication module of each individual logger device, where the configuration message contains time-schedule indicating time slot when each individual logger device is to wake-up to transmit measured environmental parameter(s) together with position data of the logger device to the external data processing device.

In a preferred embodiment, each of the logger devices comprises a memory for storing the measurement data, and a rechargeable power source such as a rechargeable battery, where the processor is amongst others configured to operate the power source, and the memory. Operating the power source may include optimizing the battery usage by keeping the logger device in an optimal power mode such as by transferring it from a low-power mode where it may be capable of measuring and storing environment related parameters to a higher-energy which is the power mode necessary for transmitting the measured environment related parameters and the position data of the data logger to the external data processing device.

In an embodiment, the communication module comprises a modem controlled by the processor, where the step of temporarily waking-up the logger devices to transmit the measured environmental parameters together with position data of the logger devices to the external data processing device includes temporarily activating, by the processor, the modem from being in a low-level mode to a higher-level mode while the transmission takes place. The at least one sensing device includes a temperature sensor, and where temperature measurement takes place at a pre-defined time interval, wherein the step of configuring the logger devices to sequentially spread-out the transmission of the measured environmental parameters together with the position data for said common shipment is performed either prior to or subsequent to the temperature measurements.

In an embodiment, the at least one sensing device is selected from one or more of the following: a temperature sensor, a humidity sensor, an accelerator, a light intensity sensor, or a barometer.

In a preferred embodiment, the logger device according to the present invention is reusable, but a common lifespan of the logger device is 5-7 years, or even more.

In general the various aspects of the invention may be combined and coupled in any way possible within the scope of the invention. These and other aspects, features, and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 shows a prior art system for controlling multiple wireless logger devices associated with a common shipment,

FIG. 2 shows an embodiment of a system according to the present invention for controlling multiple wireless logger devices associated with a common shipment 1, and

FIG. 3 depicts graphically another alternative of the embodiment shown in FIG. 2 showing where the interval between the logger devices is distributed unevenly, and

FIG. 4 shows a flowchart of a method according to the present invention.

### DESCRIPTION OF EMBODIMENTS

FIG. 2 shows an embodiment of a system 100 according to the present invention for controlling multiple wireless logger devices 101-103 associated with a common shipment 111, which may comprise sensitive goods such as food products, or medicine.

Each of the logger devices comprises a processor 118, a memory 117, a power source 116 which may be rechargeable, at least one sensing device 115, and a communication module 119. Memory 117 is configured for storing measurement data measured by the at least one sensing device 115 which may in one embodiment be selected from one or more of: a temperature sensor, an accelerometer, a humidity sensor, a barometer or a light sensor. Where the measured environmental parameters are thus selected from one or more of the following: temperature of the shipment (ambience temperature of the shipment and/or the temperature within the shipment), the acceleration or vibration of the shipment, the humidity of or around the shipment, the air pressure, or the light intensity of the shipment.

The power source 116 may include a rechargeable battery, where the processor 118 is amongst others configured to operate the power source and the communication module 119 e.g. by means of optimizing the battery usage by keeping the logger device in an optimal power mode and maintain maximum time of the power charge. As depicted here, the communication module 119 comprises a modem 120 such as a cellular modem, for communicating with a cellular network such as 2G, 3G, 4G, or 5G network. An example of keeping the logger device in an optimal power mode is to adjust the modem 120 to a low-power mode when no transmission of data takes place. In this mode, the logger device measures environmental related parameters such as temperature e.g. every 10 minutes where the measured temperature is stored in memory 117. A power-consuming process is where the logger device is put temporarily to wake-up mode while transmitting the data to the external data processing device 110, but this is done by placing the modem temporarily to a higher power mode while the transmission takes place and then back to the low-power mode.

The logger devices 101-103 are configured to measure said environmental parameters in a supply chain while transporting the shipment from an origin location to a destination location and temporarily wake-up to transmit the measured environmental parameters 104-106 to the external data processing device 110 to allow real-time monitoring of the shipment 111, meaning that the location data of the shipment together with the measured environmental parameters are thus made available in real-time.

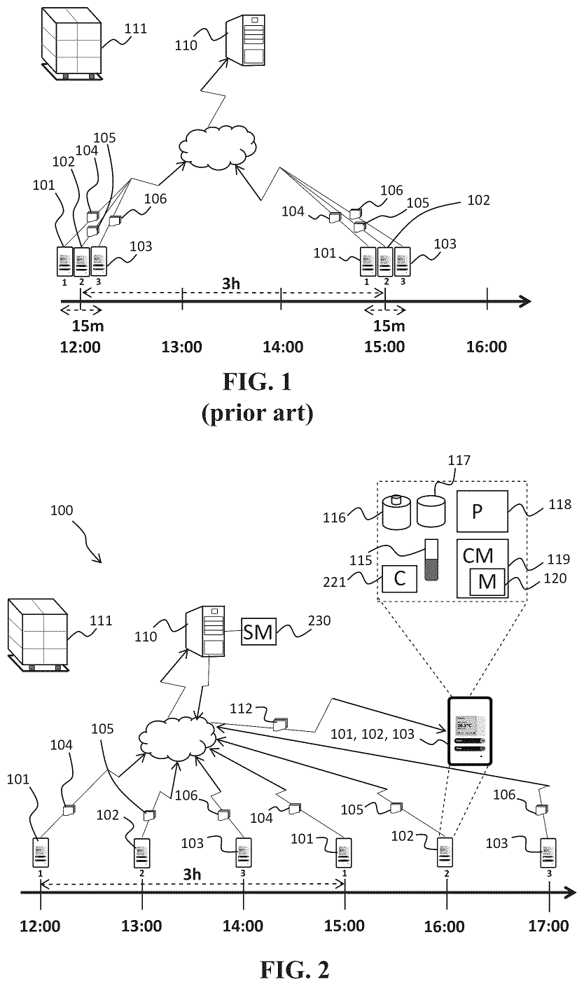

As depicted here, the logger devices 101-103 belonging to the same shipment receive a transmission schedule generated by a scheduling module 230, which may be comprised in the external data processing device 110, for scheduling the transmission of the logger devices such that the transmission of the measured environmental parameters together with the position data for said shipment is sequentially spread-out, and thus fills into the otherwise present 3 hour wakeup gap in the prior art solution depicted in FIG. 1. The sequentially spread-out transmission is repeatedly performed within the fixed time-interval which as shown in this example is 3 hours. In that way, the use of the three logger devices is maximized and used to enhance the “resolution” of the position data of the data loggers/shipment.

In the embodiment shown here, the step of configuring the logger devices 101-103 includes scheduling a fixed transmission sequence between individual logger devices, i.e. the sequence logger “1”-logger “2”-logger “3” is fixed and is repeated as shown.

Moreover, as shown in this embodiment the transmission sequence of the logger devices is scheduled such that a single logger transmits the measured environmental parameter(s) together with position data of the logger device at a time where the time interval between the logger devices is distributed evenly, i.e. 1 hour interval which is determined based on the (fixed time-interval)/(number of logger devices associated to the same shipment). In this case, 3 h/3 loggers=1 h/logger.

In an embodiment, each of the logger devices further comprises a built-in clock module 221, where the step of configuring the logger devices is triggered through a remotely sent configuration message 112 sent to each individual logger device 101-103 and received by the communication module 119. The configuration message may as an example be sent from the external data processing device 110, where the configuration message contains amongst others a time-schedule indicating when each individual logger device is to wake-up to transmit measured environmental parameter(s) together with position data of the logger device to the external data processing device.

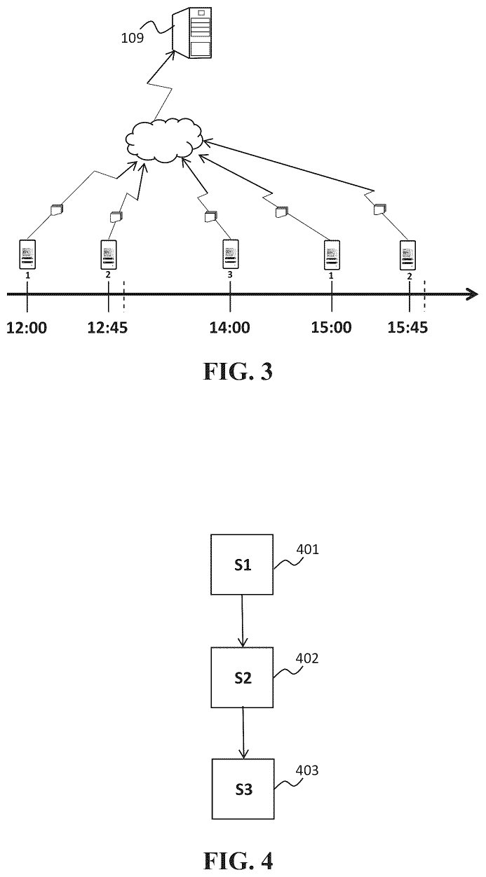

FIG. 3 depicts graphically another alternative of the embodiment shown in FIG. 2 showing where the interval between the logger devices is distributed unevenly, but there may be several reasons for such an uneven distribution, such as preventing the wake-up mode of the logger device from intervening with the temperature measurements within the logger devices. The reason is that when the modem is moved to a higher-energy mode the surrounding temperature in the logger devices increases and thus affects the temperature measurements taken at that time.

FIG. 4 shows an embodiment of a method according to the present invention controlling multiple wireless logger devices associated with a common shipment, where the logger devices are configured to measure environmental parameters while transporting the shipment from an origin location to a destination location and temporarily wake-up to transmit the measured environmental parameters together with position data of the logger devices to an external data processing device.

In step S1 (401), two or more logger devices are associated with the common shipment, which may e.g. be any type of food product or medicine shipment.

In step S2 (402), the logger devices receive a configuration message sent to each individual logger device, where the configuration message contains time-schedule indicating when each individual logger device is to wake-up to transmit measured environmental parameter(s) together with the position data of the logger device to the external data processing device. The configuration message contains amongst others information about where each logger device is to wake-up and the wake-up sequence as discussed previously in relation to FIGS. 2 and 3. Other information may as an example include information relating to the shipment, such as temperature restrictions, such as max or min temperatures, and fixed time-interval, which may also be understood as a wake-up interval for the shipment.

In step S3 (403), the message is processed by each individual logger device resulting in the logger devices sequentially spreading out the transmission of the measured environmental parameters together with the position data for said common shipment, where the sequentially spread-out transmission is repeatedly performed within the fixed time-interval.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art of practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

1.-13. (canceled)

14. A method of controlling multiple wireless logger devices associated with a common shipment, where the logger devices are configured to measure environmental parameters while transporting the shipment from an origin location to a destination location and temporarily wake-up to transmit the measured environmental parameters together with position data of the logger devices to an external data processing device, where each of the logger devices comprises:
at least one sensing device for measuring at least one environmental parameter of the shipment, and
a communication module for transmitting the measured environmental parameter to the external data processing device,
wherein the method comprises configuring the logger devices to sequentially spread-out the transmission of the measured environmental parameters in a controlled way together with the position data for said common shipment, where the sequentially spread-out transmission is repetitively performed within a fixed time-interval.

15. The method according to claim 14, wherein the step of configuring the logger devices includes scheduling a fixed transmission sequence between individual logger devices.

16. The method according to claim 15, wherein the transmission sequence of the logger devices is scheduled such that a single logger device transmits measured environmental parameter(s) together with the position data of the logger device once at a time.

17. The method according to claim 16, wherein the time interval between the logger devices is distributed evenly.

18. The method according to claim 14, wherein each of the logger devices further comprises a built-in clock module, where the step of configuring the logger devices is triggered through remotely sent configuration messages sent to each individual logger device and received by the communication module of each individual logger device, where the configuration messages contain time-schedule indicating when each individual logger device is to wake-up to transmit measured environmental parameter(s) together with the position data of the logger device to the external data processing device.

19. The method according to claim 14, where the communication module comprises a modem controlled by a processor comprised in each of the logger devices, where the step of temporarily waking-up the logger devices to transmit the measured environmental parameters together with the position data of the logger devices to the external data processing device includes temporarily activating, by the processor, the modem from being in a low-level mode to a higher-level mode while the transmission takes place.

20. The method according to claim 14, wherein the at least one sensing device includes a temperature sensor, where the temperature measurement takes place at a pre-defined time interval,
wherein the step of configuring the logger devices to sequentially spread-out the transmission of the measured environmental parameters together with the position data for said common shipment is performed either prior to or subsequent to the temperature measurements.

21. The method according to claim 14, wherein the measured environmental parameters are selected from one or more of the following: temperature, humidity, acceleration, vibration, light intensity, and/or air pressure.

22. A system for monitoring environmental parameters of a shipment while transporting the shipment from an origin location to a destination location, comprising:
an external data processing device,
two or more wireless logger devices associated to said shipment configured to measure environmental parameters of the shipment while transporting the shipment from an origin location to a destination location, where each logger device comprises:
a processor,
at least one sensing device for measuring at least one environmental parameter of the shipment,
a communication module operated by the processor where the operation includes temporarily setting the logger device in a wake-up mode while transmitting the measured environmental parameter(s) together with position data of the logger device to the external data processing device, and
a scheduling module configured to generate a transmission schedule for the two or more logger devices such that the transmission of the measured environmental parameters together with the position data for said common shipment is sequentially spread out, where the sequentially spread-out transmission is repeatedly performed within a fixed time-interval.

23. The system according to claim 22, wherein the schedule module is comprised within the external data processing device, where each of the logger devices further comprises a built-in clock module, where the step of configuring the logger devices is triggered through a remote configuration message sent from the external data processing device to each individual logger device and received by the communication module, where the configuration message contains a time-schedule indicating when each individual logger device is to wake-up to transmit measured environmental parameter(s) together with position data of the logger device to the external data processing device.

24. The system according to claim 22, where the communication module comprises a modem controlled by the processor, where the step of temporarily waking-up the logger devices to transmit the measured environmental parameters together with the position data of the logger devices to the external data processing device includes temporarily activating, by the processor, the modem from being in a low-level mode to a higher-level mode while the transmission takes place.

25. The system according to claim 22, wherein the at least one sensing device includes a temperature sensor, and where temperature measurement takes place at a pre-defined time interval,
wherein the step of configuring the logger devices to sequentially spread-out the transmission of the measured environmental parameters together with the position data for said common shipment is performed either prior to or subsequent to the temperature measurements.

26. The system according to claim 22, wherein the at least one sensing device is selected from one or more of the following: a temperature sensor, a humidity sensor, an accelerator, a light intensity sensor, or a barometer.
